(19) United States
(12) Patent Application Publication
(10) Pub. No.: US 2017/0298990 A1
(43) Pub. Date: Oct. 19, 2017

(54) SELF-LUBRICATING ROLLER BEARING AND METHODS OF MAKING AND USING SELF-LUBRICATING ROLLER BEARING

(71) Applicant: CATERPILLAR INC., PEORIA, IL (US)

(72) Inventors: RYAN A. LOZIER, PEORIA, IL (US); THIERRY A. MARCHIONE, HEBER CITY, UT (US)

(73) Assignee: CATERPILLAR INC., PEORIA, IL (US)

(21) Appl. No.: 15/131,710

(22) Filed: Apr. 18, 2016

(51) Int. Cl. F16C 33/66; B22F 3/105; F16C 33/64; B22F 5/10; F16C 33/34; B33Y 10/00; B33Y 80/00

(52) U.S. Cl. CPC F16C 33/6696; B22F 5/106; B22F 3/1055; F16C 33/34; F16C 33/64; B33Y 80/00; B33Y 10/00; F16C 2220/20

(57) ABSTRACT

A self-lubricating roller bearing is provided. The roller bearing includes an inner race, an outer race, and a plurality of rollers between the inner and outer races. Each of the inner race and the outer race includes a bearing surface for contact with the rollers. The bearing surface of one or more of the inner race, the outer race, and the rollers has one or more laser hardened areas and one or more non-laser hardened areas arranged in a predetermined pattern. The one or more non-laser hardened areas create dry lubricant for the roller bearing upon wear thereof.

### TECHNICAL FIELD

The present disclosure generally relates to bearings, and more particularly to self-lubricating roller bearings and methods of making and using self-lubricating roller bearings.

### BACKGROUND

Roller bearings are often used with rotating elements of machines, such as vehicles, turbines, pumps and the like. Roller bearings support rotating elements while also constraining relative motion of rotating elements. Typically, a roller bearing includes an inner race and an outer race concentric with the inner race. In a space defined between the inner race and the outer race, a set of rolling elements or rollers is provided. The rolling elements facilitate relative movement between the inner race and the outer race. During operation of the roller bearings, i.e., during relative movement of the inner race with respect to the outer race, contact surfaces of the inner race, the outer race and the rolling elements can experience continuous fatigue load, which can cause wear of the contact surfaces and may ultimately lead to failure of the roller bearing.

Lubrication may be provided to reduce wear of contact surfaces of the roller bearing. The lubrication may be provided to the roller bearing during initial assembly of the roller bearing. In such a case, the service life of the roller bearing may be dependent upon the amount or type of lubrication initially provided, since lubricant replenishment after initial assembly of the roller bearing may not be practical or possible.

U.S. Pat. No. 4,323,401, hereinafter referred to as the '401 patent, describes a bearing in a confined liquid environment having a generally flat planar surface of pearlite and an array of microasperities of martensite on the planar surface. According to the '401 patent, each microasperity includes a gently sloping front surface in relation to the direction of movement of the bearing and a sharply sloping rear surface in relation to such direction of movement. As described in the '401 patent, a pulsed laser beam or other heat source is focused on the bearing to produce the array with microasperities of controlled size and shape.

### SUMMARY OF THE DISCLOSURE

In one aspect of the present disclosure, a self-lubricating additive manufactured steel roller bearing is provided. The roller bearing includes an additive manufactured steel inner race, an additive manufactured steel outer race, and a plurality of additive manufactured steel rollers contacting the inner and outer races and arranged in a space between the inner and outer races. Each of the inner race and the outer race includes a bearing surface facing the space, where the bearing surface includes a plurality of laser hardened areas arranged in a predetermined pattern and a non-laser hardened area having respective portions separating adjacent laser hardened areas of the predetermined pattern. The laser hardened areas are harder than the non-laser hardened area. Further, the laser hardened areas extend a predetermined depth from the bearing surface, the predetermined depth being less than a maximum depth by which the non-laser hardened area extends from the bearing surface. The non-laser hardened area is a sacrificial bearing surface that creates a dry lubricant upon wear of the non-laser hardened area, and the laser hardened areas are load bearing portions of the roller bearing. The laser hardened areas have a metal infiltrated lattice structure, particularly a bronze infiltrated lattice structure according to one or more embodiments of the disclosed subjected matter.

In another aspect of the present disclosure, a self-lubricating metal roller bearing is provided. The roller bearing includes a metal inner race, a metal outer race, and a plurality of metal rollers arranged in a space between the inner and outer races. At least one of the inner and outer races includes a surface facing the space. The surface has a laser hardened portion and a non-laser hardened portion arranged in a predetermined pattern. The laser hardened portion is harder than the non-laser hardened portion and has a slower wear rate than the non-laser hardened portion. The non-laser hardened portion is a sacrificial bearing surface that creates dry lubricant for the roller bearing upon wear of the non-laser hardened portion, and the laser hardened portion is load bearing. The laser hardened portion and the non-laser hardened portion are at a same height on the surface facing the space.

In yet another aspect of the present disclosure, a method regarding a self-lubricating bearing is provided. The method includes providing a plurality of laser hardened portions for at least one of an inner race and an outer race of a roller bearing; and providing a plurality of non-laser hardened portions for the at least one inner race and outer race of the roller bearing. The laser hardened portions and the non-laser hardened portions are arranged in a predetermined pattern. The non-laser hardened portions create dry lubricant upon wear thereof, and the laser hardened portions are load bearing. The laser hardened portions and the non-laser hardened portions are at a same height defining a bearing surface of the at least one inner race and outer race of the roller bearing.

Other features and aspects of this disclosure will be apparent from the following description and the accompanying drawings.

### BRIEF DESCRIPTION OF THE DRAWINGS

The accompanying drawings, which are incorporated in and constitute a part of the specification, are illustrative of one or more embodiments of the present disclosure and, together with the description, explain the embodiments. The accompanying drawings have not necessarily been drawn to scale. Further, any values or dimensions in the accompanying drawings are for illustration purposes only and may or may not represent actual or preferred values or dimensions. Where applicable, some or all select features may not be illustrated to assist in the description and understanding of underlying features.

FIG. 1 is a perspective partial cross-sectional diagrammatic representation of an example of a portion of a roller bearing according to one or more embodiments of the present disclosure;

FIG. 2 is a diagrammatic representation of a cross section of a variation of the roller bearing of FIG. 1 taken along X-X′;

FIG. 3 is a diagrammatic representation of a cross section of a variation of the roller bearing of FIG. 1 taken along X-X′, according to one or more embodiments of the present disclosure;

FIG. 4 is an enlarged diagrammatic representation of a portion of a cross section of an outer race of a roller bearing according to one or more embodiments of the present disclosure;

FIG. 5 is a partial plan view of a representation of a portion of a bearing surface of a roller bearing according to one or more embodiments of the present disclosure;

FIG. 6 is a flowchart of a method regarding a roller bearing (and components thereof) according to one or more embodiments of the present disclosure;

FIG. 7 is a diagrammatic representation of a plan view cross section of an exemplary unit cell taken at a first depth from a bearing surface, according to one or more embodiments of the present disclosure;

FIG. 8 is a diagrammatic representation of a plan view cross section of the exemplary unit cell of FIG. 7 at a second depth from the bearing surface, according to one or more embodiments of the present disclosure; and

FIG. 9 is a flowchart of a method regarding a roller bearing (and components thereof) according to one or more embodiments of the present disclosure.

### DETAILED DESCRIPTION

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, well-known structures and components may be shown in block diagram form in order to avoid obscuring the concepts of the described subject matter. Wherever possible, corresponding or similar reference numbers will be used throughout the drawings to refer to the same or corresponding parts.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the described subject matter to any particular orientation or configuration. Furthermore, terms such as “first,” “second,” “third,” etc. merely identify one of a number of portions, components, points of reference, operations or functions as described herein, and likewise do not necessarily limit embodiments of the described subject matter to any particular configuration, orientation, or sequence of functions or operations.

Generally speaking, embodiments of the described subject matter relate to bearings, and more particularly to bearings that are constructed to self-lubricate. Specific embodiments described herein involve rolling-element bearings, also referred to as “roller bearings,” particularly self-lubricating metal roller bearings constructed to self-lubricate with dry lubricant (i.e., introduce new dry lubricant to wear surfaces) upon wear of certain predetermined sacrificial wear portions thereof. Such self-lubrication can be performed without unpacking, opening, or unsealing a bearing case of the bearing. Of course, embodiments of the disclosed subject matter can include plain or solid bearings or components thereof.

Selective laser hardening can be used to create a bearing structure having hardened bearing surface portions to carry the load of the bearing, while leaving sacrificial wear surface portions to introduce “new” dry lubricant to wear surfaces of the bearing upon wear thereof. Further, each of the components of the bearing structure, according to embodiments of the disclosed subject matter, may be created using additive manufacturing (e.g., 3-D printing) or using a non-additive manufactured manufacturing technique, such as die casting, etc.

Thus, selective laser hardening can be done after a bearing component is created using additive manufacturing (e.g., selective laser sintering (SLS), direct metal laser sintering (DMLS), or selective laser melting (SLM)) or a non-additive manufactured manufacturing technique. Alternatively, selective laser hardening can be done on a section-by-section basis (i.e., layer by layer) as part of an additive manufacturing technique (e.g., SLS, DMLS, or SLM). A tooling path for the laser to take to create a three-dimensional component of the bearing can be generated using software, where the tool path includes where and under what control parameters the laser will create selectively hardened portions of the component.

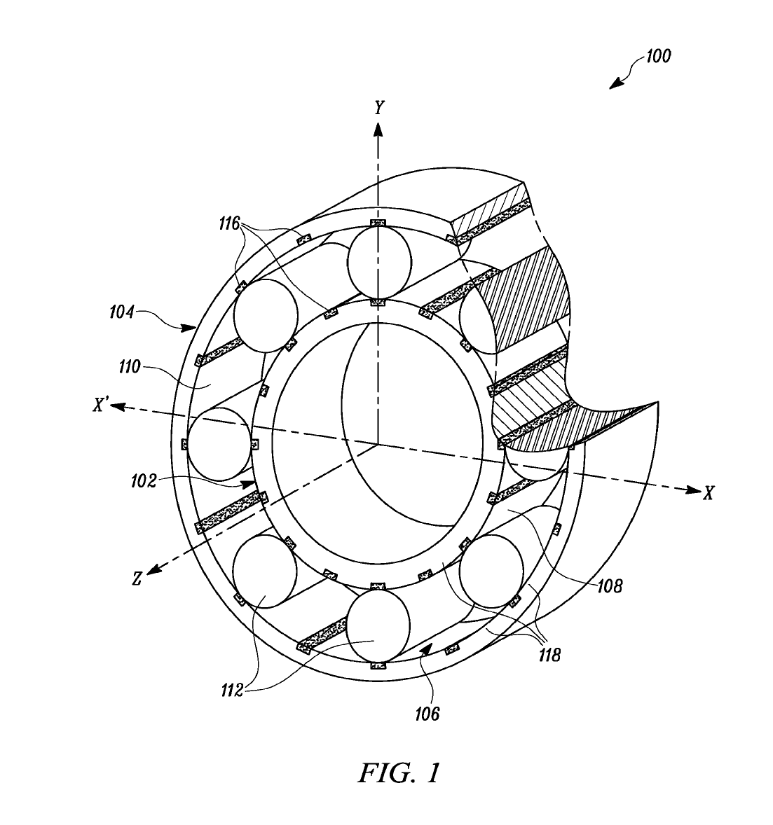

FIG. 1 illustrates a perspective partial cross-sectional diagrammatic representation of an example of a portion of a roller bearing 100 according to one or more embodiments of the disclosed subject matter. The roller bearing 100 may be hereinafter interchangeably referred to as a “self-lubricating additive manufactured steel roller bearing,” and a “self-lubricating metal roller bearing,” without any limitations.

The roller bearing 100 can include an inner race 102, an outer race 104, a plurality of rolling elements or rollers 112 between the inner race 102 and the outer race 104, and a space 106 between the inner race 102 and the outer race 104, the space being comprised of a plurality of space portions between the rollers 112. Optionally, the roller bearing 100 can include a case (not expressly shown) that can enclose or seal the space 106 at opposite ends of the roller bearing 100 (i.e., along the Z-axis), for instance, to enclose or keep in any dry lubricant initially provided to the roller bearing 100 and “self-lubricant” created by wear of sacrificial wear portions of the inner race 102, the outer race 104 and/or the rollers 112 of the roller bearing 100, and to prevent undesired entry of impurities into the space 106. Roller bearing 100 may also optionally have a cage or cage portions configured to hold the rollers 112.

Generally speaking, the inner race 102 and the outer race 104 can have a hollow cylindrical configuration with respective internal and external surfaces. Further, the inner race 102 may be hereinafter interchangeably referred to as an “additive manufactured steel inner race,” and an “metal inner race,” without any limitations, and the outer race 104 may be hereinafter interchangeably referred to as an “additive manufactured steel outer race,” and a “metal outer race,” without any limitations. To be clear, each of the inner race 102 and the outer race 104 can be created using additive manufacturing (e.g., SLS, DMLS, or SLM) or using a non-additive manufactured manufacturing technique. Further, both the inner race 102 and the outer race 104 can be made of a same or different metal able to be hardened using a laser hardening process (e.g., a directed energy deposition process), such as tool steel, carbon steel, or stainless steel.

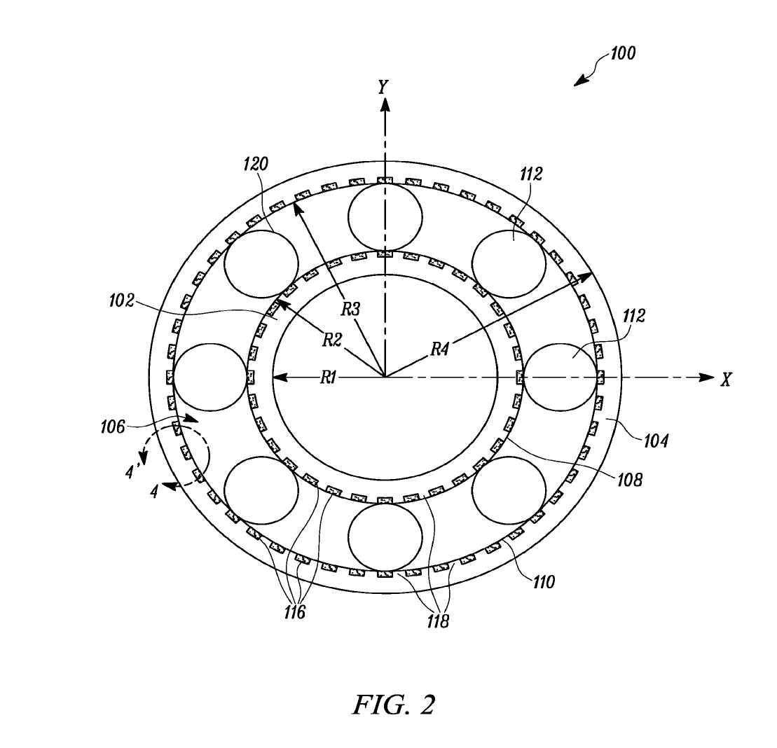

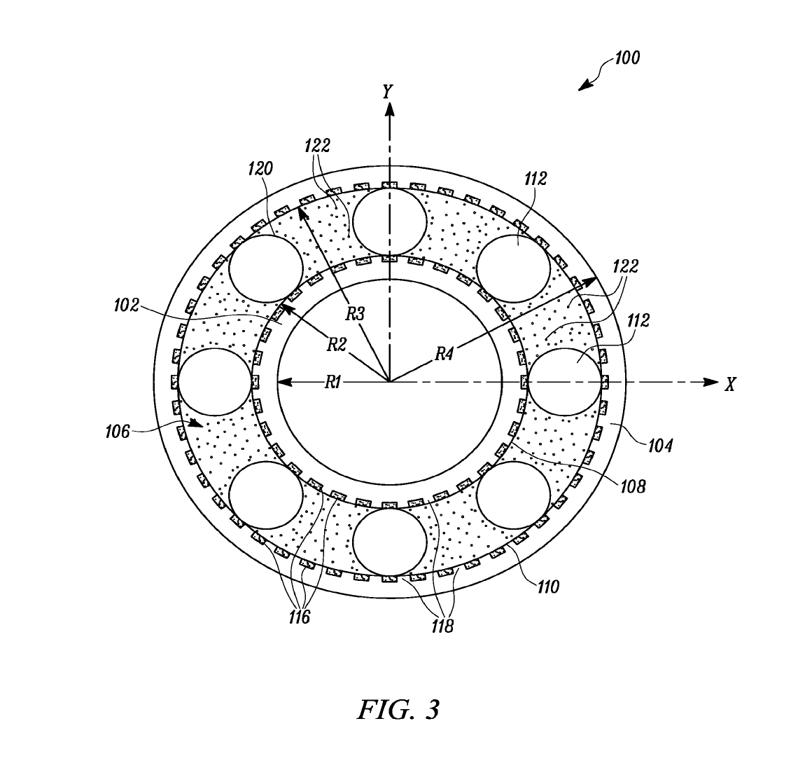

As illustrated in FIG. 2 and FIG. 3, which show variations of the roller bearing of FIG. 1 in terms of the patterning of laser hardened and non-laser hardened portions or areas, the inner race 102 has an inner radius “R1” and an outer radius of “R2” from a center axis of the roller bearing 100 along the Z-axis. Likewise, the outer race 104 has an inner radius “R3” and an outer radius “R4” from the center axis of the roller bearing 100 along the Z-axis. The inner radius “R3” of the outer race 104 is greater than the outer radius “R2” of the inner race 102, and the outer race 104 is positioned concentrically over the inner race 102 such that space 106 (including spaces between adjacent rollers 112) is defined between the outer race 104 and the inner race 102. More specifically, the outer race 104 and the inner race 102 face the space 106 defined between a bearing surface 108 of the inner race 102 at the outer radius “R2” of the inner race 102 and a bearing surface 110 at the inner radius “R3” of the outer race 104.

Optionally, the space 106 between the inner race 102 and the outer race 104 and surrounding the rollers 112 is initially filled with air or a partial vacuum, upon first packing the roller bearing 100. As a result of wear, the space 106 may have introduced thereto dry lubricant from sacrificial wear portions of the inner race 102, outer race 104, and/or rollers 112. FIG. 2 shows an example according to one or more embodiments of the disclosed subject matter where space 106 is not provided initially with dry lubricant. That is, FIG. 2 can represent an embodiment whereby the roller bearing 100 is packed or sealed without dry lubricant.

Alternatively, the space 106 may have been provided with an initial amount of dry lubricant for the roller bearing, such as, but not limited to, a graphite-based dry lubricant or molybdenum, or any other dry lubricant, provided during initial assembly of the roller bearing 100, and wear of sacrificial wear portions of the inner race 102, outer race 104, and/or rollers 112 can introduce additional dry lubricant to wear surfaces of the roller bearing 100. FIG. 3 shows an example of particles 122 of sacrificial wear material from one or more of the inner race 102, outer race 104, and rollers 112 provided in the space 106 along with dry lubricant initially provided upon packing or sealing the roller bearing 100.

Each of the rollers 112, which are interchangeably referred to herein as “steel rollers,” or “plurality of additive manufactured steel rollers,” includes a bearing surface 120. Respective portions of the bearing surfaces 120 of the rollers 112 can remain in contact with the bearing surface 108 of the outer race 104 and the bearing surface 110 of the inner race 102. Further, the rollers 112 can have a spherical, cylindrical or frusto-conical shape. 100321 The bearing surface 108 of the outer race 104 and/or the bearing surface 110 of the inner race 102 can include a plurality of laser hardened areas 116 (also interchangeably referred to as “laser hardened portions”) and a non-laser hardened area(s) 118 (also interchangeably referred to as “non-laser hardened portion”).

The plurality of laser hardened areas 116 can be arranged on one or both of the bearing surface 108 of the outer race 104 and the bearing surface 110 of the inner race 102 in a predetermined pattern or patterns. In one embodiment of the present disclosure, the predetermined patterns in which the laser hardened areas 116 are arranged on the inner race 102 can be different from the predetermined pattern in which the laser hardened areas 116 are arranged on the outer race 104. Alternatively, the predetermined pattern in which the laser hardened areas 116 are arranged on the inner race 102 is the same as or similar to the predetermined pattern in which the laser hardened areas 116 are arranged on the outer race 104, of course, factoring in the differences in size between the two components. Further, the plurality of laser hardened areas 116 can be evenly spaced around an entirety of the bearing surface 108 and the bearing surface 110, respectively, in a tangential direction. Additionally or alternatively, the plurality of laser hardened areas 116 can be evenly spaced around the entirety of the bearing surface 108 of the outer race 104 and the bearing surface 110 of the inner race 102 in a direction along the Z-axis. Likewise, the non-laser hardened area 118 may be arranged on the bearing surface 108 of the outer race 104 and the bearing surface 110 of the inner race 102 such that the non-laser hardened area 118 have portions that separate, partially or entirely, the adjacent laser hardened areas 116.

A sum of surface areas of all the plurality of laser hardened areas 116 per component or per combination of components can define a total surface area of the laser hardened areas 116. In an example, the sum of surface areas of the plurality of laser hardened areas 116 of the inner race 102 and the outer race 104 defines the total surface area of the laser hardened areas 116.

Optionally, the total surface area of the laser hardened areas 116 (per component or per combination of components) is less than a surface area of the non-laser hardened area 118. In such an example, the total surface area of the laser hardened areas 116 may be less than 50% of the surface area of the non-laser hardened area 118. Alternatively, the total surface area of the laser hardened areas 116 (per component or per combination of components) may be greater than the surface area of the non-laser hardened area 118. In such an example, the total surface area of the laser hardened areas 116 may be more than 50% (for example 51% to 95%) of the surface area of the non-laser hardened area 118. As yet another alternative, the total surface area of the laser hardened areas 116 (per component or per combination of components) may be equal to the surface area of the non-laser hardened area 118.

Regarding the above, different ratios of the total surface area of the laser hardened areas 116 to the surface area of the non-laser hardened area 118 may be selected based on a plurality of factors, such as depth of wear geometry of the hardened portion at various depths, rate analysis of wear rates of the material(s) of the inner race 102 and the outer race 104 in its original state as compared to the wear rates of material of the inner race 102 and the outer race 104 in its hardened state, predetermined patterns of the laser hardened areas 116, etc.

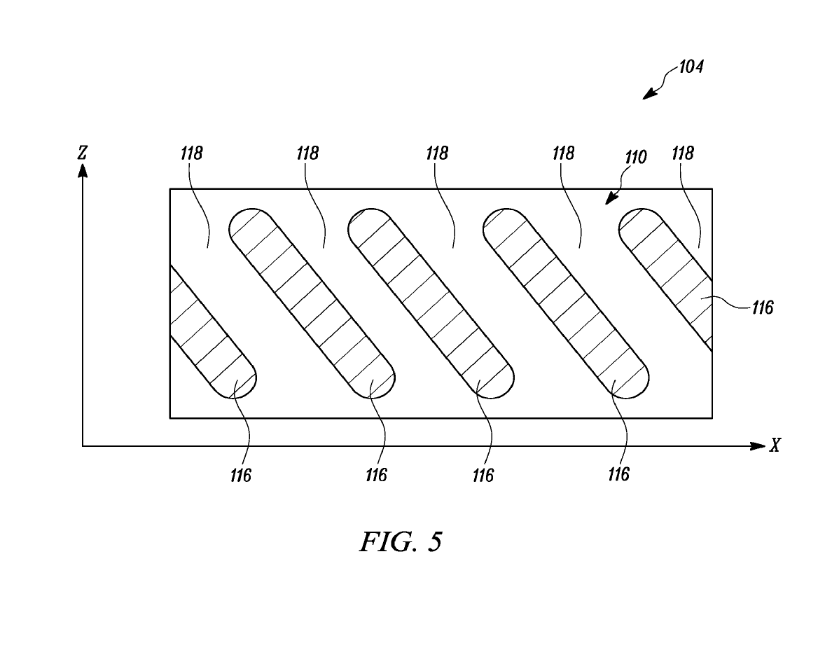

To be clear, the arrangement, orientation, and dimensions of the laser hardened areas 116 and consequently the non-laser hardened area 118 illustrated in FIGS. 1-3 is intended to diagrammatically represent, by way of one specific, non-limiting example, the aspect of the present disclosure of plural, spaced-apart laser hardened areas and consequently the non-laser hardened area as viewed from the surface. In this regard, it is clear that many other patterns may be employed, such as angled laser hardened and/or non-laser hardened areas, or laser hardened and/or non-laser hardened areas that run in a tangential direction entirely or partially around the circumference of the corresponding inner or outer race or roller. FIG. 5 discussed below provides another non-limiting example of a laser hardened/non-laser hardened pattern according to one or more embodiments of the disclosed subject matter.

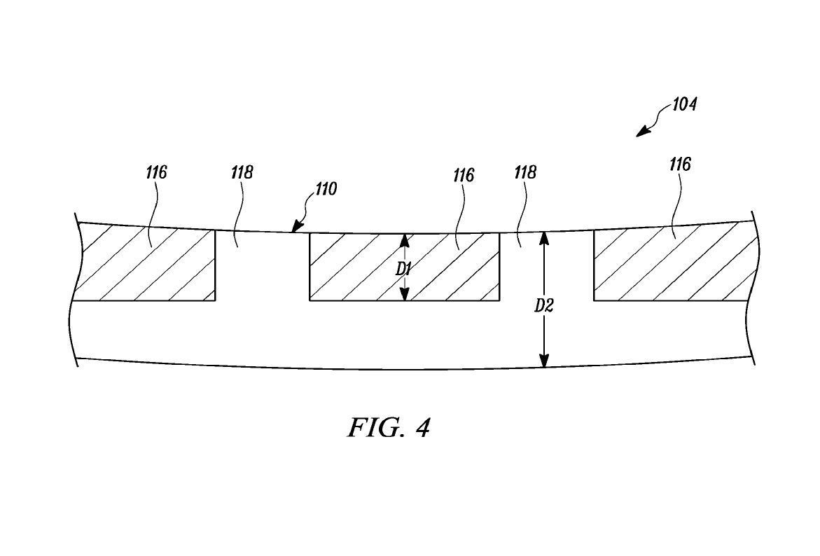

Referring now to FIG. 4, this figure provides a diagrammatic representation of a portion of a cross-section of the outer race 104 of the roller bearing 100 showing non-laser hardened area 118 (or areas) and laser hardened areas 116 on the bearing surface 110 of the outer race 104. The laser hardened areas 116 can extend by a depth “D1,” for instance, predetermined, from the bearing surface 110. The non-laser hardened area 118 also extends by a predetermined depth “D2” from the bearing surface 110, which may represent the total thickness of the outer race 104. The depths “D1” and “D2” are distance values (which may also be referred to as “heights”) measured from the inner surface of the outer race 104 from the bearing surface 110 radially outward in relation to a central axis of the roller bearing 100 at the Z-axis.

In one or more embodiments of the disclosed subject matter, the predetermined depth “D1” may be less than the predetermined depth “D2.” Further, optionally, the laser hardened areas 116 and the non-laser hardened area(s) 118 may be flush with each other to form the bearing surface 110. Thus, in such an embodiment the laser hardened areas 116 and the non-laser hardened area(s) 118 are a same distance away from the central axis of the roller bearing 100 at the Z-axis. In alternative examples, the predetermined depth “D1” may be greater than or equal to the predetermined depth “D2.”

In one or more embodiments, the non-laser hardened area(s) 118 may extend above the laser hardened areas 116 at the bearing surface 110 such that the non-laser hardened area(s) 118 are closer to the central axis of the roller bearing 100 at the Z-axis than are the laser hardened areas 116. As a result, upon initial operation the non-laser hardened area(s) 118 can wear before the laser hardened areas 116 are reached and provide dry lubricant to the roller bearing 100 to lubricate wear surfaces of the laser hardened areas 116 (i.e., bearing surface 110). Further, when the non-laser hardened area(s) 118 extends beyond the laser hardened areas 116 on the bearing surface 110, a better mating fit can be created, for instance, as the inner race 102, the outer race 104, and the rollers 112 can be allowed to wear themselves into a mating interface (or a more effective mating interface). Subsequently, the laser hardened portions can be allowed to bear the load after the inner race 102, the outer race 104, and the rollers 112 have seated. Optionally, in one or more embodiments, only a non-laser hardened area may form the bearing surface 110, i.e., a non-laser hardened area initially covers the laser hardened area(s) 118, whereby operation of the roller bearing and consequent wear of the non-laser hardened area must occur to expose the laser hardened area(s) 118.

Once the non-laser hardened area 118 have worn below the laser hardened areas 116 (i.e., when the non-laser hardened area(s) 118 are below or recessed relative to the laser hardened areas 116 at the bearing surface 110), further wear of the non-laser hardened sacrificial portions can occur when the laser hardened areas 116 wear down (albeit at a slower rate than the non-laser hardened area 118) such that the laser hardened areas 116 are at a same level again with the non-laser hardened area(s) 118.

Although FIG. 4 illustrates the laser hardened areas 116 and the non-laser hardened area 118 in reference to the outer race 104, in one or more embodiments, the aspects of laser hardened areas 116 and the non-laser hardened area 118 discussed above relative to the outer race 104 can equally or substantially apply to the inner race 102 and/or the rollers 112.

Turning now to FIG. 5, which, generally speaking, is representative of a top plan view of the bearing surface 110 (without the curvature of the bearing surface expressly represented) having laser hardened areas 116, also referred to as “laser hardened portions,” arranged in a predetermined pattern, with a predetermined surface geometry, and according to a particular orientation. That is, the laser hardened areas 116 can be arranged in a predetermined pattern with respect to the non-laser hardened area 118 on the bearing surface 110 of the outer race 104.

FIG. 5 provides an example of a predetermined pattern for the laser hardened areas 116 with respect to the non-laser hardened area(s) 118 on the bearing surface 110 of the outer race 104. Further, the laser hardened areas 116 are embodied in FIG. 5 as a plurality of distinct laser hardened portions defining geometric volumes in the at least one of the inner race 102 and the outer race 104. However, optionally, the laser hardened portions or areas may not be distinct in that portions thereof may be connected either at the bearing surface or below the bearing surface. It is also noted that FIG. 5 may likewise be representative of a predetermined pattern of laser hardened areas 116 with respect to the non-laser hardened area 118(s) on the bearing surface 108 of the outer race 102. Of course, embodiments of the disclosed subject matter are not limited to the predetermined pattern or surface geometry laser hardened areas 116 shown in FIG. 5.

As shown in FIG. 5, the laser hardened areas 116 may be angled at a predetermined angle relative to the X-axis and/or the Z-axis. Likewise, portions of the non-laser hardened area 118 (i.e., portions between the laser hardened areas) are angled at a predetermined angle relative to the X-axis and/or the Z-axis. Further, optionally, the laser hardened areas 116 and/or the portions of the non-laser hardened area 118 may overlap with reference to the Z-axis and/or the X-axis. Further, according to one or more embodiments of the disclosed subject matter, a laser hardened portion, such as laser hardened area 116, must be crossed when going from one edge or side of the component to the other in the direction of the Z-axis. Providing angled laser hardened areas 116 and/or overlapping one or more of laser hardened areas 116 and portions of the non-laser hardened area 118, such as illustrated in FIG. 5 or discussed above, can provide a continuous roller support and/or continuous contact with non-laser hardened area 118 so new lubricant from the non-laser hardened area 118 can be continuously provided.

Generally speaking, the laser hardened areas 116 are harder than the non-laser hardened area 118, and thus, serve as load bearing portions. Put another way, the laser hardened areas 116 can have a slower wear rate as compared to the non-laser hardened area(s) 118. Further, the non-laser hardened area(s) 118 can form a sacrificial bearing surface that creates dry lubricant upon wear thereof. More specifically, during roller bearing operation frictional contact occurs between various wear surfaces of the outer race 104 and the rollers 112 and the inner race 102 and the rollers 112. As a result, portions of the non-laser hardened area(s) 118 acting as a sacrificial bearing surface can abrade and introduces dry lubricant in the form of dry particles, such as particles 122, into the space 106, which can work their way on and over wear surfaces in the space 106 so as to provide lubricant to the wear surfaces. As discussed in more detail below, each of the laser hardened areas 116 can have a lattice structure that is infiltrated, for instance, with a material that has a relatively good or high ductility and/or that is sufficiently hard for load bearing, such as a metal (e.g., bronze).

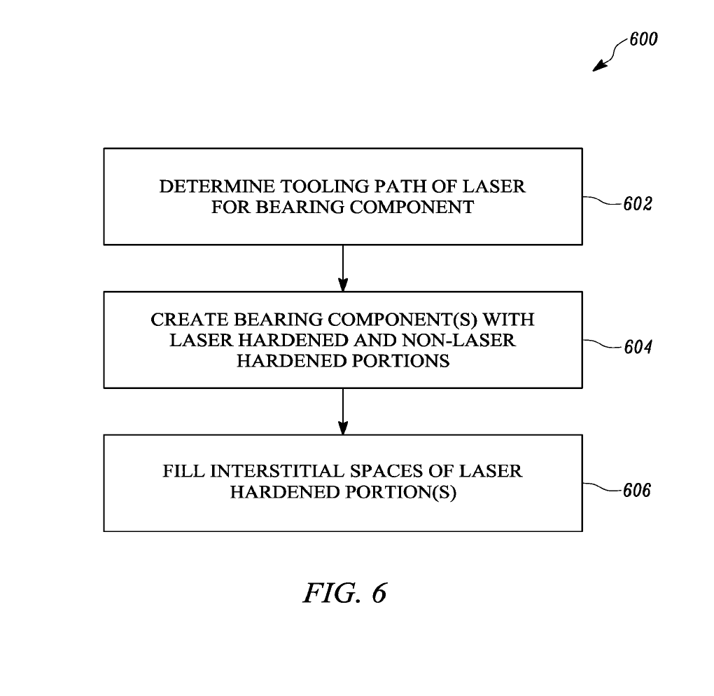

FIG. 6 is a flowchart of a method of forming a roller bearing or component thereof according to one or more embodiments of the disclosed subject matter.

The method 600, at step 602, can include determining a tooling path of a laser (or other controlled energy source) to create one or more bearing components of a roller bearing, such as one or more of the inner race 102, the outer race 104 and the rollers 112, collectively referred to herein as “bearing components” of the roller bearing 100. The laser path may be modeled and/or controlled using software.

At step 604 the method 600 can create one or more bearing components, such as the inner race 102, the outer race 104 and the rollers 112, one or more of which have laser hardened to result in non-laser hardened areas or portions and laser hardened areas or portions as discussed above, using the determined tooling path. Further, the bearing component(s) may be created using an additive manufacturing technique, such as 3-D (Three-Dimensional) printing. In this regard, any material that comes in a powdered form and is suitable for additive manufacturing may be used. In various embodiments of the present disclosure, the material may be tool steel, carbon steel (e.g., carburizing alloy steel, such as 8620 steel), stainless steel (e.g., 420 stainless steel), or any alloy that can be readily be hardened via heat treatment. Further, the additive manufacturing technique may be SLS, DMLS, or SLM. Selective laser hardening can be carried out on the bearing component created by the additive manufacturing technique, after the component has been created and/or on a section-by-section basis using additive manufacturing. Alternatively, one or more of the bearing components may be created or provided using a non-additive manufacturing technique. In this regard, the selective laser hardening to create laser hardened and non-laser hardened areas can be performed to a bearing surface thereof after the bearing component is created.

To create the laser hardened and non-laser hardened areas, for instance, in a predetermined pattern, a directed energy source, such as a laser, can provide energy to the bearing components, guided based on the determined tooling path. The tooling path includes a path along which the laser moves while dissipating energy on surfaces of the bearing components. Therefore the tooling path of the laser, and the selective control of laser control parameters, can create the predetermined pattern of the laser hardened areas 116 and the non-laser hardened area 118. More specifically, the tooling path and various laser operating parameters, such as an amount of energy output (e.g., increasing an amount of energy), exposure time (e.g., increasing exposure time), wavelength (e.g., decreasing wavelength/increasing frequency), changing the applied area (e.g., increasing the applied area), and/or changing beam spot size (e.g., increasing beam spot size), can be varied to create the laser hardened areas 116 of any suitable proportions relative to non-laser hardened area 118, geometries (including surface geometries at different depths), spatial relationships with other laser hardened portions or sides or faces, angles, etc. Thus, by changing the tooling path of the laser and various parameters any predetermined pattern of laser hardened and non-laser hardened areas can be created to meet specifications relating to the materials of the component(s) or roller bearing, roller bearing application, load requirements, and/or amount of lubricant desired or needed, for instance.

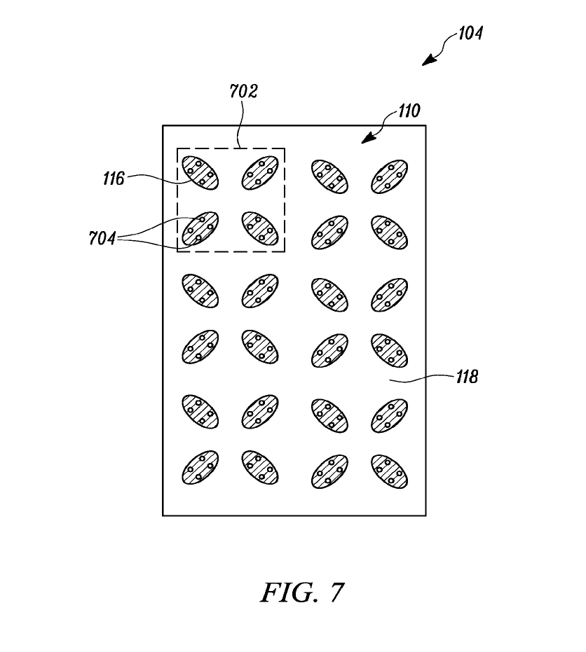

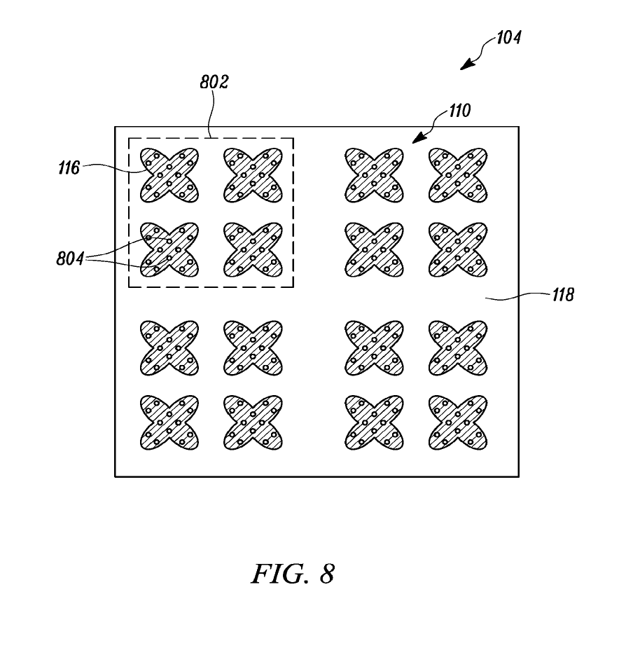

A plurality of unit cellular level geometric shapes (i.e., porous geometric structures) can be defined or modeled within software and form the basis to create the laser hardened areas. Based on commands executed by software, one or more of such unit cellular level geometric shapes may be modeled. The unit cellular level shapes, shown in FIG. 7 as unit 702 and in FIG. 8 as unit 802 at different cross-sectional depths, can have any suitable geometry, such as a jack (i.e., a six-pointed star with rounded heads on the ends of four points and pointed heads on the two remaining points), a cross-hatch, circles with dots in the middle, spheres that intersect at their largest circumference, a cylinder, a cube or cuboid, or some other primitive geometry. Further, the geometric shapes can have a symmetric or asymmetric shape.

Additionally, the geometric shapes can be arranged together in a variety of predetermined ways with respect to each other. The geometric shapes and/or arrangement in the roller bearing model can be driven by Finite Element Analysis (FEA) or physical testing and then expanded to a macroscale (i.e., of the bearing design). Based on the geometric shape and positioning, software, for instance, can cause the tooling path to move the laser to selectively harden areas so as to form the modeled geometric shape for the unit cellular level.

As noted above, software, for instance, can also contain information pertaining to an amount of power to be supplied by the laser and a required beam spot size of the laser, required to create selected geometric shapes on the bearing component. By controlling the amount of energy supplied by the laser to a preselected unit area, the predetermined depth “D1” of the laser hardened areas 116 may be controlled. For example, by increasing the amount of energy supplied by the laser (e.g., a 6 kW laser) to a preselected unit area (i.e., amount of energy per square area), the depth “D1” of the laser hardened areas 116 may be proportionately increased. The depth “D1” of the laser hardened areas 116 can also be controlled by increasing the power output of the laser as compared to the surrounding area desired to be kept as non-laser hardened area 118. Further, the depth “D1” of the laser hardened areas 116 can also be controlled by increasing exposure time of the area to the laser or changing (e.g., increasing) wavelength of the laser or increasing the amount of area over which it is applied, and/or by increasing beam spot size.

In an embodiment of the present disclosure, a computer-generated model of the three-dimensional geometric structures and the predetermined pattern of the laser hardened portions can be created using software, for instance. The three-dimensional geometric structures and the predetermined pattern of the laser hardened portions can then be formed on a layer-by-layer basis in the predetermined pattern during an additive manufacturing technique, for instance.

The method 600 can also include, at step 606, a treatment process, which may be interpreted as a post-treatment process. For example, step 606 can include providing interstitial spaces of the unit cell 704, 804 with a material after such unit cells have been formed into laser hardened areas. For example, a material with relatively good ductility may be provided to the interstitial spaces of the laser hardened areas. The ductile material may be bronze or any other material having suitable ductility and suitable for load bearing. In an example, the supply of the ductile material to the interstitial spaces such as the interstitial space 704 and the interstitial space 804 of the laser hardened areas can be done by placing the bearing component(s) or roller bearing in a sintering furnace with bronze. In such an example, capillary action will cause bronze to get filled into the interstitial space of the laser hardened areas and form a bronze infiltrated lattice structure.

Method 600 may also optionally include as a post-treatment process a nitrating process. Such treatment process can create a hardness up to 62 HRC, for instance, and provide desirable or increased anti-friction and/or anti-galling properties for the bearing components.

### INDUSTRIAL APPLICABILITY

The present disclosure relates to roller bearings, such as roller bearing 100, which may include cylindrical roller bearings, spherical bearings, tapered roller bearings, or frusto-conical roller bearings. The roller bearing can be manufactured using an additive manufacturing technique or using a non-additive manufacturing technique. Bearing surfaces of one or more of the inner race 102, the outer race 104 and the plurality of rollers 112 can include a plurality of laser hardened areas 116 and non-laser hardened area 118. Further, non-laser hardened portions of one or more of the inner race, the outer race, and the rollers of the roller bearings can be caused to abrade so as to introduce “new” dry lubricant to wear surfaces of the inner race, the outer race, and the rollers.

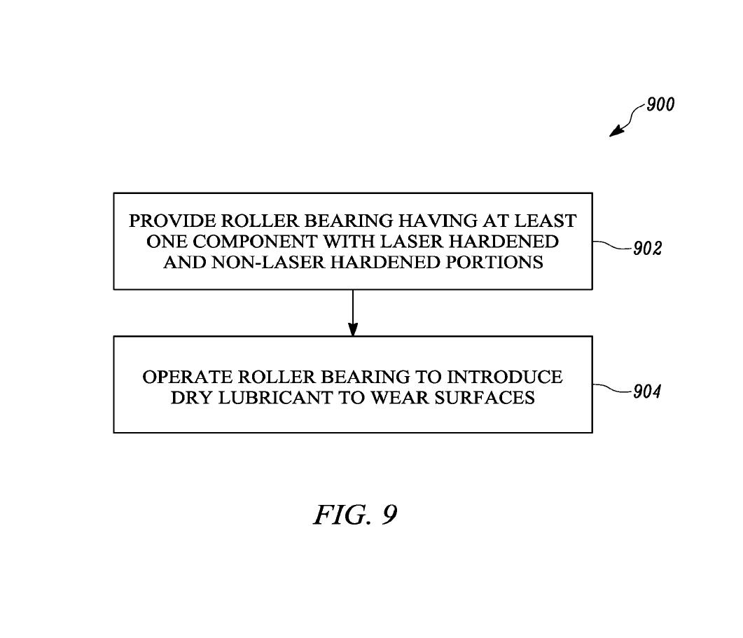

FIG. 9 shows a flowchart of a method 900 of forming and using a roller bearing according to one or more embodiments of the disclosed subject matter.

The method 900, at step 902, includes providing a roller bearing, such as roller bearing 100, having at least one component with laser hardened and non-laser hardened portions or areas, such as discussed above relative to FIGS. 1-8.

The method 900, at step 904, can operate the roller bearing. Operation of the roller bearing can cause the non-laser hardened area(s) to abrade and create dry lubricant, which is introduced into the space(s) between the inner and outer races to lubricate wear surfaces of the inner race, the outer race, and the rollers. Further, generally speaking, when operating the roller bearing, the non-laser hardened area can wear faster than the laser hardened areas. In other words, the non-laser hardened area 118 wears over time based on the wear imposed by the rollers 112, which is faster that the wear of the laser hardened areas. As a result, the non-laser hardened area abrades so as to form dry particles, which can disperse over the roller bearing 100 and can function as dry lubricant for the roller bearing. This introduction of dry particles to the roller bearing 100 as a result of abrading of the non-laser hardened area 118 can enable the roller bearing to continuously self-lubricate.

As is evident from the above, since the abrading of the non-laser hardened area 118 introduces “new” dry lubricant into the space 106, lubricant can be provided to the roller bearing 100 without having to open, unpack, or unseal the roller bearing 100. Further, introduction of “new” dry lubricant into the space 106 by abrading of the non-laser hardened area can provide lubricant in the space even after the initially provided dry lubricant has been exhausted or is otherwise no longer suitable as lubricant.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A self-lubricating additive manufactured steel roller bearing comprising:
an additive manufactured steel inner race;
an additive manufactured steel outer race; and
a plurality of additive manufactured steel rollers contacting the inner and outer races and arranged in a space between the inner and outer races,
wherein each of the inner race and the outer race includes a bearing surface facing the space, each of the bearing surfaces having a plurality of laser hardened areas arranged in a predetermined pattern and a non-laser hardened area with respective portions separating adjacent laser hardened areas of the predetermined pattern, the laser hardened areas being harder than the non-laser hardened area,
wherein the laser hardened areas extend a predetermined depth from the bearing surface, the predetermined depth being less than a maximum depth by which the non-laser hardened area extends from the bearing surface,
wherein the non-laser hardened area is a sacrificial bearing surface that creates a dry lubricant upon wear of the non-laser hardened area,
wherein the laser hardened areas are load bearing portions of the roller bearing, and
wherein the laser hardened areas have a bronze infiltrated lattice structure.

2. The roller bearing of claim 1, wherein, for each of the inner and outer races, a total surface area of the laser hardened areas is different from a surface area of the non-laser hardened area.

3. The roller bearing of claim 1, further comprising a case sealing the space between the inner and outer races.

4. The roller bearing of claim 1, wherein the space between the inner and outer races includes a dry lubricant of a material different from a material of the non-laser hardened area.

5. The roller bearing of claim 1,
wherein, for the outer race, inner-most surfaces of the laser hardened areas and the non-laser hardened area are different distances away from a central axis of the roller bearing, and
wherein, for the inner race, outer-most surfaces of the laser hardened areas and the non-laser hardened area are different distances away from the central axis of the roller bearing.

6. A self-lubricating metal roller bearing comprising:
a metal inner race;
a metal outer race; and
a plurality of metal rollers arranged in a space between the inner and outer races,
wherein at least one of the inner and outer races includes a surface facing the space, the surface having a laser hardened portion and a non-laser hardened portion arranged in a predetermined pattern, the laser hardened portion being harder than the non-laser hardened portion and having a slower wear rate than the non-laser hardened portion,
wherein the non-laser hardened portion is a sacrificial bearing surface that creates a dry lubricant for the roller bearing upon wear of the non-laser hardened portion,
wherein the laser hardened portion is load bearing, and
wherein the laser hardened portion and the non-laser hardened portion are at a same height on the surface facing the space.

7. The roller bearing of claim 6, wherein the laser hardened portion extends to a predetermined depth from the surface.

8. The roller bearing of claim 6, wherein the laser hardened portion has a predetermined geometry.

9. The roller bearing of claim 6, wherein the laser hardened portion is comprised of a plurality of distinct laser hardened portions defining geometric volumes in the at least one of the inner and outer races.

10. The roller bearing of claim 6, wherein each of the inner race and the outer race includes the surface facing the space having the laser hardened portion and the non-laser hardened portion arranged in the predetermined pattern.

11. The roller bearing of claim 6, wherein the space between the inner and outer races includes a dry lubricant of a material different from a material of the non-laser hardened portion.

12. The roller bearing of claim 6, wherein the laser hardened portion is exposed only after wear of the non-laser hardened portion.

13. The roller bearing of claim 6, wherein the laser hardened portion is a metal infiltrated lattice structure infiltrated with a metal different from a metal of the non-laser hardened portion.

14. The roller bearing of claim 6, wherein a total surface area of the laser hardened portion is greater than a total surface area of the non-laser hardened portion.

15. The roller bearing of claim 6, wherein a total surface area of the laser hardened portion is less than a total surface area of the non-laser hardened portion.

16. A method comprising:
providing a plurality of laser hardened portions for at least one of an inner race and an outer race of a roller bearing; and
providing a plurality of non-laser hardened portions for the at least one inner race and outer race of the roller bearing,
wherein the laser hardened portions and the non-laser hardened portions are arranged in a predetermined pattern,
wherein the non-laser hardened portions create a dry lubricant upon wear thereof,
wherein the laser hardened portions are load bearing, and
wherein the laser hardened portions and the non-laser hardened portions are at a same height defining a bearing surface of the at least one inner race and outer race of the roller bearing.

17. The method of claim 16, further comprising:
operating the at least one inner race and outer race of the roller bearing such that the non-laser hardened portions wear faster than the laser hardened portions and abrade so as to introduce dry particles to the roller bearing as the dry lubricant.

18. The method of claim 16, further comprising:
causing the non-laser hardened portions to abrade to introduce dry particles to the roller bearing as the dry lubricant.

19. The method of claim 16, further comprising:
introducing the dry lubricant to the roller bearing without opening, unpacking, or unsealing the roller bearing.

20. The method of claim 16, further comprising:
performing selective laser hardening to create the laser hardened portions and the non-laser hardened portions arranged in the predetermined pattern.
